(19) United States
(12) Patent Application Publication
(10) Pub. No.: US 2011/0063829 A1
(43) Pub. Date: Mar. 17, 2011

(54) Lamp For Lightweight Steel Frame

(75) Inventor: Hsueh-Chen Chen, Taichung County (TW)

(73) Assignee: RODAN (TAIWAN) LTD., Taichung County (TW)

(21) Appl. No.: 12/560,399

(22) Filed: Sep. 15, 2009

(51) Int. Cl. F21V 9/00; F21S 4/00

(52) U.S. Cl. 362/231; 362/235; 362/294

(57) ABSTRACT

The present invention provides a lamp for lightweight steel frame, comprising: a first frame, containing a power supply module at the back, at least two heat sinks at both sides of the power supply module, and a conductor for electrical connection with the power supply module; at least a LED assembly mounted in front of the first frame; the LED assembly is electrically connected with the conductor to form a spotted light source; at least a reflector used to convert the spotted light source into directional beam for projection into external environment; the reflector is installed within the front of first frame; a second frame for the lightweight steel frame, defining a space for covering the first frame; two diffusers arranged between the reflector and substrate, as well as a condenser between the diffusers. With this design, the reflector could project the directional beam into intended external environment for improved power consumption, environmental protection and illuminance.

### BACKGROUND OF INVENTION

1. Field of the Invention

The present invention relates generally to a lamp, and more particularly to an innovative one which is used for light steel frame thanks to its advantages such as: energy conservation, environmental protection and improved illuminance.

2. Description of Related Art

The fluorescent lamps are generally used as lighting sources for everyday life and transaction activities of the people.

To meet the home or office environment, the fluorescent lamp is often installed in a lightweight steel framework, thus forming a lightweight steel frame lamp. A plurality of fluorescent lamp tubes are embedded into a recessed portion of the steel frame, and electrically connected with the power supply module. As such, the heavy metal—mercury contained in the lamp tube will be activated to generate energy, which is converted into light source penetrating the aforementioned lamp for illumination.

However, this typical lightweight steel frame lamp shall be improved due to its environmental pollution caused by the mercury contained thereof, as well as excessive power consumption.

### SUMMARY OF THE INVENTION

The primary objective of the present invention is to provide a lightweight steel frame lamp for energy conservation and environmental protection & preservation.

Another objective of the present invention is to provide a lightweight steel frame lamp for higher degree of illuminance.

For these purposes, the lamp for lightweight steel frame comprising:

a first frame, containing a power supply module at the back, at least two heat sinks at both sides of the power supply module, and a conductor for electrical connection with the power supply module;

at least a LED assembly mounted in front of the first frame; the LED assembly is electrically connected with the conductor to form a spotted light source;

at least a reflector used to convert the spotted light source into directional beam for projection into external environment; the reflector is installed within the front of first frame;

a second frame, defining a space for covering the first frame;

two diffusers arranged between the reflector and substrate, as well as a condenser between the diffusers.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

Referring to FIGS. 1˜4, the preferred embodiment of the lamp for lightweight steel frame comprising:

a first frame 1, containing a power supply module 11 at the back, at least two heat sink units 12 at both sides of the power supply module 11, and a conductor 13 for electrical connection with the power supply module 11;

at least a LED assembly 2 mounted in front of the first frame 1; the LED assembly 2 is electrically connected with the conductor 13 to form a spotted light source;

at least a reflector 7 used to convert the spotted light source into directional beam for projection into external environment; the reflector 7 is installed within the front of first frame;

a second frame 5 in the lightweight steel frame 6, defining a space 51 for covering the first frame 1 from down to up. So, several elements could be accommodated between the first frame 1 and the space 51, but at least a heat sink unit 12 is not covered to ensure that the heat sink unit 12 could still be operated.

Furthermore, the preferred embodiment of the lamp for lightweight steel frame also comprising: a transparent substrate 3 arranged between the bottom of reflector 7 and the second frame 5. It is worthy to note that, the substrate 3 is made of glass or acryl plate. In this preferred embodiment, the substrate 3 is made of acryl plate.

The heat sink unit 12 could discharge the heat energy generated by LED assembly 2.

LED assemblies 2 are symmetrically arranged at both sides of the first frame 1 for forming horizontal beam. A flexible color scheme is made possible for LED assemblies 2 since beams of different colors are emitted.

The second frame 5 is sized bigger than the first frame 1, so both frames could be assembled smoothly.

Two diffusers 8 may be arranged, if necessary, between the reflector 7 and the substrate 3, and a condenser 9 is arranged between the diffusers 8 to improve the illuminance. In such case, the substrate 3 could be made of thin-profile materials for lightweight design.

The first frame 1 is made of reinforced materials. In this preferred embodiment, the first frame 1 is made of metal material.

The first frame 1 in this preferred embodiment is designed into a rectangular shape, so the inner space of the present invention can be saved.

The second frame 5 is made of reinforced materials. In this preferred embodiment, the second frame 5 is made of metal material.

The second frame 5 in this preferred embodiment is designed into a rectangular shape, so the inner space of the present invention can be saved.

Referring to FIG. 5, the preferred embodiment of the lightweight steel frame lamp is subject to illuminance test at room temperature 25° C., at an international unit Lux, namely, place the measurement instrument at a certain height, and measure Lux every hour. It is learnt in the figure that a stable illuminance could be obtained at two heights.

As shown in FIG. 5, the “table height” means the height of 174.3 cm measured when the measurement instrument is placed on the table; the “ground height” means the height of 251.3 cm measured when the measurement instrument is placed on the ground.

Referring to FIGS. 1˜4, the second frame 5 is embedded and fixed into a lightweight steel frame 6, the power supply module 11 is electrically connected with the power supply, and output via conductor (13) to LED assembly 2; the heat sink unit (12) could discharge the heat energy generated by LED assembly 2, which projects the spotted light source onto the reflector 7; then, the reflector 7 converts the light source into directional beam for projection into the external environment. In addition, the diffuser 8 and condenser 9 could be arranged between the reflector 7 and substrate 3, if necessary, to improve the illuminance.

As compared with typical lightweight steel frame lamp, the present invention has the following advantages:

1. Lower power consumption/maintenance cost and longer service life for LED assembly; the power consumption could save up to 60%-90%, and LED assembly could be activated rapidly in low-voltage environment.

2. LED assembly doesn't contain mercury, without the hazard of environmental pollution.

3. The illuminance could be further improved with additional installation of diffuser and condenser.

On the other hand, the present invention also has the following characteristics:

1. The reflector could convert the spotted light source of LED assembly into directional beam.

2. A flexible color scheme is made possible for LED assemblies.

3. The first and second frames could be designed in a manner to save the space, resist the shock and compression.

Although the invention has been explained in relation to its preferred embodiment, it is to be understood that many other possible modifications and variations can be made without departing from the spirit and scope of the invention as hereinafter claimed.

### BRIEF DESCRIPTION OF THE DRAWINGS

FIG. 1 depicts an assembled outside view of a preferred embodiment of the present invention.

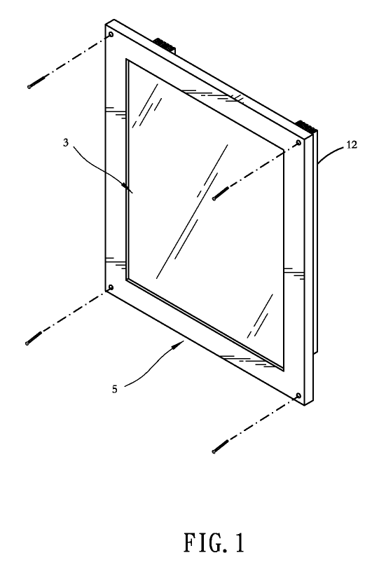

FIG. 2 depicts an exploded & partially enlarged perspective view of a preferred embodiment of the present invention.

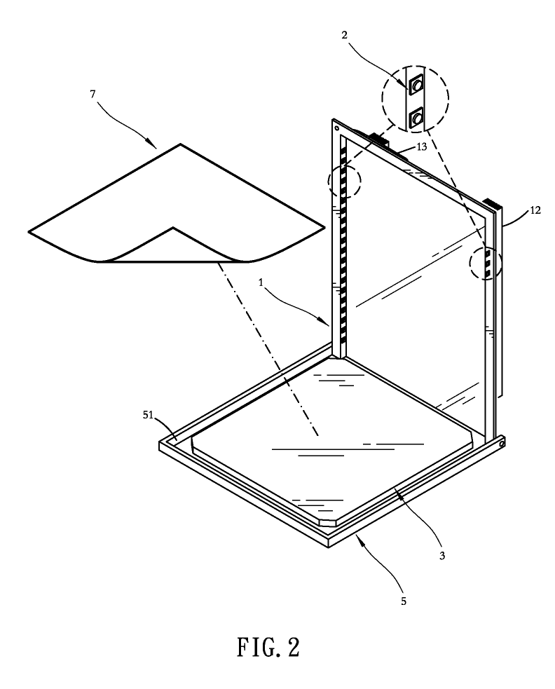

FIG. 3 depicts a view of a preferred embodiment of the present invention applied to lightweight steel frame.

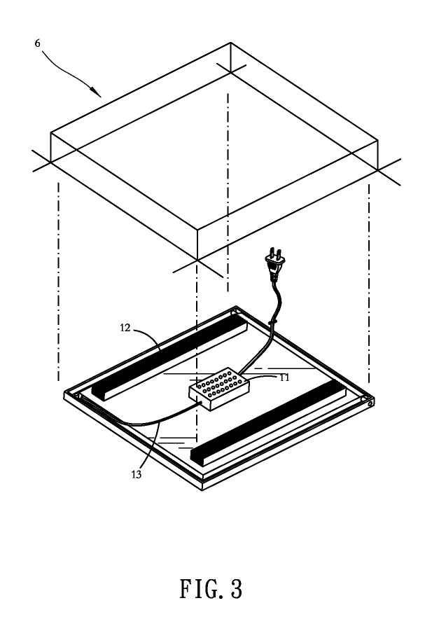

FIG. 4 depicts a view of a preferred embodiment of the present invention with additional installation of diffuser and condenser.

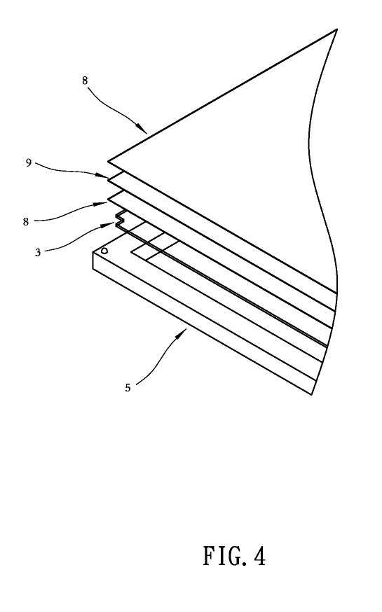

FIG. 5 depicts an illuminance test diagram of a preferred embodiment of the present invention.

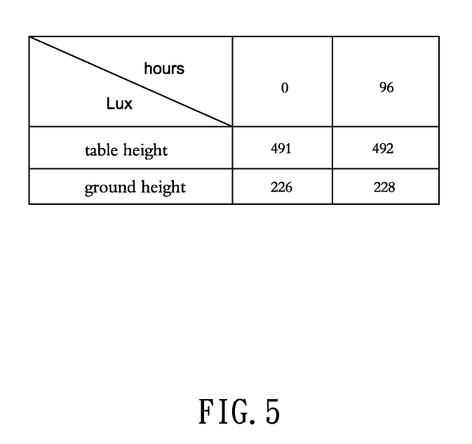

1. A lamp for lightweight steel frame, comprising:
a first frame, containing a power supply module at the back, at least two heat sinks at both sides of the power supply module, and a conductor for electrical connection with the power supply module;
at least a LED assembly mounted in front of the first frame; the LED assembly is electrically connected with the conductor to form a spotted light source;
at least a reflector used to convert the spotted light source into directional beam for projection into external environment; the reflector is installed within the front of first frame; and
a second frame for the lightweight steel frame, defining a space for covering the first frame.

2. The structure defined in claim 1, wherein a transparent substrate is arranged between the bottom of reflector and the second frame.

3. The structure defined in claim 1, wherein the substrate is made of glass or acryl plate.

4. The structure defined in claim 1, wherein the heat sink unit is used to discharge the heat energy generated by LED assembly.

5. The structure defined in claim 1, wherein LED assemblies are symmetrically arranged at both sides of the first frame for forming horizontal beam.

6. The structure defined in claim 1, wherein LED assembly could emit beams of different colors.

7. The structure defined in claim 1, wherein the second frame is sized bigger than the first frame.

8. The structure defined in claim 1, wherein it comprises two diffusers as well as a condenser between the diffusers; the diffusers and condenser are arranged between the reflector and the substrate.
